(19) United States
(12) Patent Application Publication
(10) Pub. No.: US 2026/0155782 A1
(43) Pub. Date: Jun. 4, 2026

(54) HYBRID SOLAR POWER GENERATION SYSTEM AND CIVIL ENGINEERING WORK WITH SUCH SYSTEM

(71) Applicant: ENERGYPIER AG, Steinhausen (CH)

(72) Inventor: Laurent JOSPIN, La Chaux-de-Fonds (CH)

(73) Assignee: ENERGYPIER AG, Steinhausen (CH)

(21) Appl. No.: 19/114,212

(22) PCT Filed: Sep. 22, 2023
(86) PCT No.: PCT/IB2023/059405

§ 371 Date: Mar. 21, 2025

(30) Foreign Application Priority Data
Sep. 22, 2022 (CH) 0010982022

(51) Int. Cl. H02S 40/44; F02G 1/04; H02K 7/18; H02S 10/10

(52) U.S. Cl. CPC H02S 40/44; F02G 1/04; H02K 7/1823; H02S 10/10; F02G 2254/30; F02G 2280/20

(57) ABSTRACT

The invention concerns a hybrid solar power generation system comprising:
a set of photovoltaic panels,
a first loop circuit containing a heat-carrying fluid able to circulate along the first loop circuit, said first loop circuit defining a first portion for circulation of the fluid in a first temperature range, a second portion adjacent to said photovoltaic panels for thermal exchange between the fluid and said photovoltaic panels and a third portion for circulation of the fluid in a second temperature range, wherein the temperatures of the second temperature range are greater than the temperatures of the first temperature range,
a heat pump with a second loop circuit containing a heat-carrying fluid, said second loop circuit passing successively through an evaporator, a compressor, a condenser and a metering device, where the heat source of said evaporator is the heat-carrying fluid present in said third portion of the first loop circuit, and
a Stirling engine, where the Stirling engine's heat source derives from heated fluid refrigerant present in a portion of the second loop circuit placed between the compressor, and the metering device.

### TECHNICAL DOMAIN

The present invention concerns the field of solar energy extraction for either individual (small or medium installations) or collective use (power grid or electric grid comprising a collection of machinery and wires that generates electricity and brings it to homes, electric vehicles, commercial and industrial areas).

There are power plants solutions where the photovoltaic panels transform solar radiations into electricity, for instance in photovoltaic power plants.

Thanks to the photovoltaic (PV) effect, solar panels first convert solar energy or sunlight into DC power. The DC power can then be stored in a battery or converted by a solar inverter into AC power which can be used to run home appliances. Depending on the type of system, excess solar energy can either be fed into the electricity grid for credits, or stored in a variety of different battery storage systems.

There is also solar thermal energy for harnessing solar energy to generate thermal energy for use in industry, and in the residential and commercial sectors. Different types of systems exist, depending notably on the temperature: low-temperature collectors, medium-temperature collectors or high-temperature collectors.

Solar thermal electricity has been of considerable interest because of its potential to lower costs. In contrast to conventional solar photovoltaic cells that produce electricity directly from sunlight, solar thermal generation of energy is developed as a large power plant in which acres of mirrors precisely reflect sunlight onto a solar receiver. That energy is notably used to heat a fluid that in turn drives a turbine to produce electricity.

In the first case, the main disadvantage concerns the limited efficiency of the solution resulting from the efficiency of the photovoltaic panels. Solar or photovoltaic panel efficiency is a measure of the amount of sunlight (irradiation) that falls on the surface of a panel and is converted into electricity, which is +/−20%. There is also a secondary disadvantage, namely that the energy produced strictly follows the addition of the sun's path and the weather conditions (directly relying on the cloud cover and air temperature). Photovoltaic solutions are therefore not manageable by themselves but require a technical complement which can be batteries, pumped storage, . . . either explicitly (local battery), or implicitly (use of the grid with all its infrastructure).

The second solution also has its drawbacks. If we consider the case of a small installation, it is in summer that the most thermal energy will be produced when it is not needed, and therefore the effective yield, calculated on the energy actually used, will collapse. On the other hand, in the case of a large installation, one may want to convert the heat obtained into electricity (not reasonably feasible in a small installation). The efficiency then falls, because to the efficiency of the collectors (max 80%), one will have to add the loss in the turbine (maximum efficiency 40% for an already very large solar field). The real efficiency then becomes 0.8×0.4=32% in theory, but actually rather 20-25%.

It should be noted that these solutions called solar thermo-electricity are reserved for hot countries, even very hot, because to make a turbine turn, it is necessary to have very high temperature steams (dry vapour), that is to say 350° Celsius and more, otherwise the output drops.

### RELATED ART

To improve the efficiency of solar thermo-electricity, several ways and attempts have been developed or are still under development. Overall photovoltaic panel efficiency can be influenced by many factors including: temperature, irradiance level, shading, panel orientation, cell type, interconnection of the cells, location (latitude), time of year, dust and dirt.

Even with the most advanced solar panels currently available according to the photovoltaic/PV cell technology, the maximum efficiency does not jump so much above 20%. Among the latest PV cell technologies, one can cite the following ones:
HJT for high-performance N-type Heterojunction cells,
TOPCon for Tunnel Oxide Passivated Contact,
Gapless Cells for High-density cell construction,
PERC for Passivated Emitter Rear Cells,
Multi Busbar for Multi ribbon and micro-wire busbars,
Split cells for half-cut and ⅓ cut cells,
Shingled Cells for Multiple overlapping cells, and
IBC for Interdigitated Back Contact cells.

In the case of large solar power plants, there has been no attempt to combine the use of photovoltaic and thermo-solar electricity. In small solar power plants, some manufacturers have tried to double the photovoltaic part of the modules with a thermal part to obtain hot water in addition to the electricity generated by the PV cells. These systems work but are relatively expensive, especially in terms of maintenance and management of the installation. Moreover, they are limited in size to the consumption of hot water directly on site There are also approaches for storage of concentrated solar thermal energy. The technology is based on thermochemical storage, in which chemical transformation is used in repeated cycles to hold heat, use it to drive turbines, and then be re-heated to continue the cycle. Most commonly this might be done over a 24-hour period, with variable levels of solar-powered electricity available at any time of day, as dictated by demand.

One can associate photovoltaic elements and heat storage elements in a module to form a solar collection and storage module system. In US2022247343A1, such a system forms a building block that can be used as wall modules to construct walls, and shingles to construct roofs of buildings.

One can also cite concentrating solar power (CSP) or solar thermal electricity, which is a complementary technology to photovoltaic/PV panels. It uses concentrating collectors to provide high temperature heat to a conventional power cycle. The concentration of direct sunlight takes place via reflective surfaces that are able to track the sun in either two or three dimensions. The redirected photons subsequently heat up a fluid that is used to drive a heat engine for the generation of electricity. These technologies have good performances but only for countries with high solar irradiance.

The available technologies present lower profitability as compared to the solar energy present in the sunlight, which give rise to reduced production of green energy in comparison to the potential production . . . : one can cite that PV or thermo-solar electricity are available but not both together.

### SUMMARY OF THE INVENTION

An aim of the present invention is the provision of a hybrid solar power generation system that overcomes the shortcomings and limitations of the state of the art.

Another aim of the invention is to raise the 20%-25% maximum efficiency of photovoltaic panels by exploiting further the thermal energy available where the photovoltaic panels are located.

According to the invention, these aims are attained by the object of the attached claims, and especially by a hybrid solar power generation system comprising:
a set of photovoltaic panels,
a first loop circuit containing a heat-carrying fluid able to circulate along the first loop circuit, said first loop circuit defining a first portion for circulation of the fluid in a first temperature range, a second portion adjacent to said photovoltaic panels for thermal exchange between the fluid and said photovoltaic panels and a third portion for circulation of the fluid in a second temperature range, wherein the temperatures of the second temperature range are greater than the temperatures of the first temperature range,
a heat pump with a second loop circuit containing a heat-carrying fluid, said second loop circuit passing successively through an evaporator, a compressor, a condenser and a metering device, where the heat source of said evaporator is the heat-carrying fluid present in said third portion of the first loop circuit, and
a Stirling engine, where the Stirling engine's heat source derives from heated fluid liquid refrigerant present in the portion of the second loop circuit placed between the compressor and the condenser.
   Also, said photovoltaic panels are mounted on supporting plates, and said second portion of said first loop circuit is running between said photovoltaic panels and said supporting plates, so that the heat-carrying fluid circulating in said second portion of said first loop circuit is able to receive some heat (quantity of joules) from the photovoltaic panels and from the supporting plates.
   In addition, an insulating layer is placed between said photovoltaic panels and said supporting plates, forming thereby a first zone of thermal exchange located between said supporting plates and said insulating layer, and a second zone of thermal exchange located between said insulating layer and said photovoltaic panels.
   Furthermore, a downstream section of said first portion of the first loop circuit is formed by a first array of parallel pipes located in said first zone of thermal exchange, an upstream section of said second portion of said first loop circuit is formed by a second array of parallel pipes located in said second zone of thermal exchange,
   and the downstream end of each pipe of the first array of parallel pipes is connected to an upstream end of a corresponding pipe of the second array of parallel pipes.

With respect to what is known in the art, the invention provides the advantage that heat present in the photovoltaic panels, which is not converted into electricity through photovoltaic effects, could be converted in a very efficient and optimized way into available additional energy through both the heat pump and the Stirling engine. In the system, the cogenerated heat is outputted in mechanical energy format by the Stirling engine. Therefore, the total energy conversion efficiency of the system is significantly improved with respect to the only efficiency of the photovoltaic panels.

In possible embodiments, the hybrid solar power generation system according to the invention further comprises a module for transformation of the mechanical motion produced by the Stirling motor into electrical output. This production of electricity as an alternative production to the mechanical production of energy renders the output of the hybrid solar power generation system more flexible in term of possible use.

Other advantages and possibilities will be presented in detail considering in the following text several embodiments of hybrid solar power generation system according to the invention.

In a possible embodiment, said supporting plates are metallic supporting plates, which enable these supporting plates to absorb the heat of the ambient environment of the supporting plates, and transmit this heat to the first zone of thermal exchange, and thereby to the first array of parallel pipes.

In a possible embodiment, said supporting plates of said set of photovoltaic panels, are forming an inclined support with a first lateral side lower than a second lateral side.

In that case, possibly, the upstream end of each pipe of the first array of parallel pipes and the downstream end of each pipe of the second array of parallel pipes are adjacent to the second lateral side of said inclined support which is higher than the first lateral side of said inclined support. Such a provision can be an advantage in terms of thermal exchange, notably in case of supporting plates forming or being part of a roof above heated circulating air.

The invention also concerns civil engineering works (e.g., infrastructure like public or private buildings or other constructed installations such as a bridge, dam, or covered roadway) comprising a protecting covering with an outer surface able to be exposed to sunlight, and comprising a hybrid solar power generation system as defined in the present text, wherein said photovoltaic panels are located on said protecting covering. It can be very advantageous to use available outside surfaces of civil engineering works to collect energy with the hybrid solar power generation system according to the present invention. Among others, those civil engineering works might be any building, including private buildings (e.g., house, apartment block, garage, factory, office building, shop, restaurant, shopping centre) or public buildings (e.g., hospital, school, administrative building, church), where the roof or similar structure is to be considered as protecting covering for the installation of the set of photovoltaic panels of the system, but also bridges, dam, railway, road, with a protecting covering along a section of the latter.

According to a possible embodiment of such civil engineering work, said photovoltaic panels, said insulating layer, said supporting plates, said first array of parallel pipes and said second array of parallel pipes are located on said protecting covering, forming thereby a photovoltaic roofing.

Such civil engineering work might comprise a portion of motorway covered with such photovoltaic roofing.

Such civil engineering work might comprise a portion of motorway covered with such protecting covering on which said photovoltaic panels are located, and forming thereby a canopy.

According to a possible embodiment of such civil engineering work, said protecting covering is inclined with two lateral sides running alongside the two sides of the motorway, the first lateral side of said protecting covering being lower than the second lateral side said protecting covering.

According to a possible embodiment of such civil engineering work, each pipe of the first array of parallel pipes and of the second array of parallel pipes extends between the first lateral side of said protecting covering and the second lateral side of said protecting covering.

According to a possible embodiment of such civil engineering work, the upstream end of each pipe of the first array of parallel pipes and the downstream end of each pipe of the second array of parallel pipes are adjacent to the second lateral side said protecting covering which is higher than the first lateral side of said protecting covering.

### BRIEF DESCRIPTION OF THE DRAWINGS

Exemplary embodiments of the invention are disclosed in the description and illustrated by the drawings in which:

FIG. 1 illustrates schematically a hybrid solar power generation system according to a first embodiment of the invention;

FIG. 2 illustrates schematically a hybrid solar power generation system according to a second embodiment of the invention;

FIG. 3 illustrates schematically a hybrid solar power generation system according to a third embodiment of the invention;

FIGS. 4a and 4b illustrate schematically a hybrid solar power generation system according to a variant of the first embodiment;

FIG. 5 is a schematic section view of a possible implementation for thermal exchange between the fluid in the first loop circuit and said photovoltaic panel, through a photovoltaic roofing system,

FIG. 6 represents more largely the implementation of FIG. 5 through a transparent perspective of the photovoltaic roofing system, and

FIG. 7 is a perspective view of a motorway covered with a canopy, forming a civil engineering work, where the canopy is formed with a photovoltaic roofing system as in FIG. 6.

### EXAMPLES OF EMBODIMENTS OF THE PRESENT INVENTION

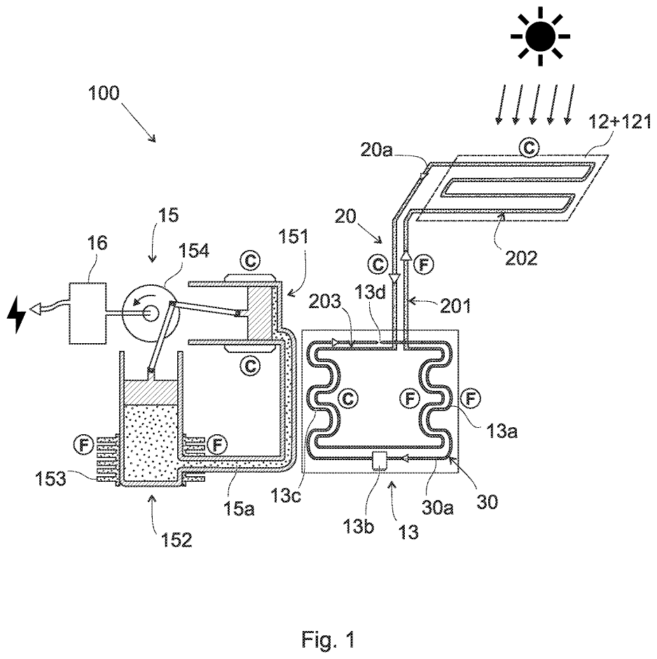

With reference to FIG. 1, a first embodiment of a hybrid solar power generation system 100 is shown and described as follows. In FIG. 1, a photovoltaic panel 12 is shown, receiving sunlight. There is a first loop circuit 20 which contains a heat-carrying fluid 20a. This first loop circuit 20 defines several portions as follows.

A first portion 201 of the first loop circuit 20 is used for circulation of the heat-carrying fluid 20a in a first temperature range, considered as a low temperature range. This first portion 201 is the portion of the first loop circuit 20 located upstream of the photovoltaic panel 12.
A second portion 202 of the first loop circuit 20 is adjacent to said photovoltaic panel 12, being placed under the photovoltaic panel 12, for thermal exchange between the heat-carrying fluid 20a and said photovoltaic panel 12: this means that when the photovoltaic panel 12 is illuminated by sun light, its temperature rises and stays hot, which enables the heat-carrying fluid 20a to be warmed along the second portion 202 of the first loop circuit 20. This second portion 202 of the first loop circuit 20 is downstream of the first portion 201 of the first loop circuit 20.
A third portion 203 of the first loop circuit 20, located downstream of said photovoltaic panel 12 contains said heat-carrying fluid 20a in a second temperature range, being greater than said first temperature range, considered as a high temperature range. This third portion 203 of the first loop circuit 20 is downstream of the second portion 202 of the first loop circuit 20 and upstream of the first portion 201 of the first loop circuit 20.

The temperatures of the second temperature range are greater than the temperatures of the first temperature range, Typically, the first temperature range or “low temperature range” is from about −40° C. to +10° C., notably about from −30° C. to 0° C., notably about from −20° C. to −10° C. or from −20° C. to −15° C. Typically, the second temperature range or “high temperature range” is about from 25° C. to 90° C., notably about from 30° C. to 80° C. or about from 45° C. to 65° C.

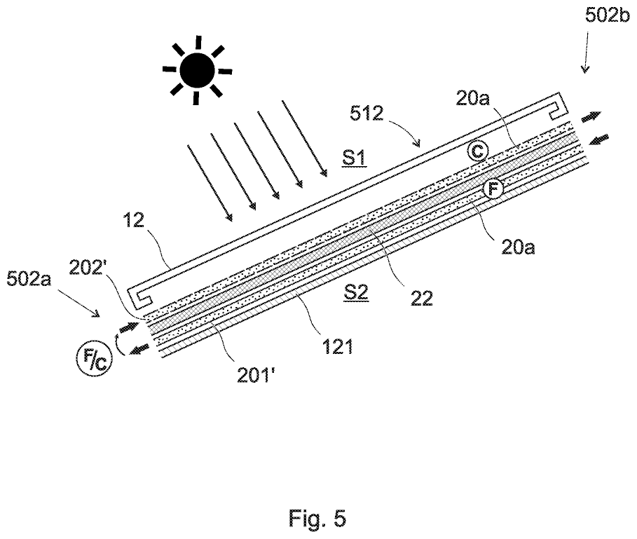

This photovoltaic panel 12 can be one photovoltaic panel 12 or a set of several photovoltaic panels 12 working independently or together, notably in series, for producing electricity via photovoltaic effect. This photovoltaic panel 12 can be part of a photovoltaic roofing 512 visible on FIGS. 5 to 7 as will be described below.

A second loop circuit 30 contains a heat-carrying fluid 30a. This second loop circuit 30 is placed close and along the third portion 203 of the first loop circuit 20 for heat exchange between them and their respective heat-carrying fluids 20a and 30a. This second loop circuit 30 corresponds to the circuit of a heat pump 13. As can be seen in FIG. 1, the second loop circuit 30 comprises several equipment for implementation of the vapor-refrigeration cycle of the heat pump 13. An evaporator 13a is located upstream of a compressor 13b, the compressor 13b is upstream of a condenser 13c; the condenser 13c is upstream a metering device 13d formed by example by an expansion valve. The compressor 13b pressurizes the heat-carrying fluid 30a and moves it throughout the second loop circuit 30. The metering device 13 regulates the flow of the refrigerant (heat-carrying fluid 30a) as it passes through the second loop circuit 30 of the heat pump 13, allowing for a reduction of pressure and temperature of the refrigerant.

The sense of circulation of the heat-carrying fluid 30a in the second loop circuit 30 is preferably inverse with respect to the sense of circulation of the heat-carrying fluid 30a in the third portion 203 of the first loop circuit 20.

Also, the first part of the third portion 203 of the first loop circuit 20 which is closed to the second loop circuit 30, in direction of flow of the heat-carrying fluid 20a, is preferably adjacent to the metering device 13d, and then to the condenser 13c.
These provisions enable a good warming of the heat-carrying fluid 30a in the second loop circuit 30, mainly at the portions of the second loop circuit 30 containing the metering device 13d, and the condenser 13c, from the heat collected by the heat-carrying fluid 20a after its passage close to the photovoltaic panel in the second portion 202 of the first loop circuit 20.

This means that, preferably downstream the end of the second portion 202 of the first loop circuit 20, the third portion 203 of the first loop circuit 20 forms successively, in direction of flow of the heat-carrying fluid 20a, a first part adjacent the metering device 13d, a second part adjacent the condenser 13c (downstream of the first part), a third part adjacent the compressor 13b (downstream of the second part), and a fourth part adjacent the evaporator 13a (downstream of the third part).

As for any heat pump, this heat pump 13 works according to the following principle in a cooling mode.

The heat carrying fluid 30a is pumped through the metering device 13d (expansion valve) at the evaporator 13a. The heat energy coming from the heat-carrying fluid 20a in the fourth part of the third portion 203 of the first loop circuit 20 is absorbed by the heat carrying fluid 30a. The process of absorbing the heat energy has caused the liquid refrigerant to heat up and evaporate into gas formed in the evaporator 13a forming a heat exchanger.

The gaseous refrigerant now passes through the compressor 13c, which pressurizes the gas. The process of pressurizing the gas causes the heat carrying fluid 30a to heat up (a physical property of compressed gases). The hot, pressurized heat carrying fluid 30a moves through the second loop circuit 30 to the condenser 13c forming a heat exchanger. Because the air outside the heat pump 13 is cooler than the hot compressed gas refrigerant in the condenser 13c, heat is transferred from the heat carrying fluid 30a (and the heat carrying fluid 20a present in the second part of the third portion 203 of the first loop circuit 20) to the air and environment of the heat pump 13 in the vicinity of the condenser 13c. During this process, the heat carrying fluid 30a condenses back to a liquid state as it cools. The warm heat carrying fluid 30a is pumped through the second loop circuit 30 to the metering device 13d (expansion valve).
The metering device 13d (expansion valve) reduces the pressure of the warm liquid heat carrying fluid 30a, which cools it significantly. At this point, the heat carrying fluid 30a is in a cool, liquid state and ready to be pumped back to the evaporator to begin the cycle again.

The refrigerant or heat carrying fluid 30a of the heat pump is chosen so that its temperature after expansion is significantly lower than the temperature of the surrounding environment (air) of the heat pump 13.

In addition, the hybrid solar power generation system 100 (first to third embodiments) comprises a Stirling engine 15. In FIGS. 1 to 4, an alpha type Stirling engine is shown but any type of Stirling engine is convenient, such as, in a non-limitative way, beta type Stirling engine and gamma type Stirling engine. Such a Stirling engine 15 defines an expansion cylinder 151, namely a hot cylinder with a wall and a piston, forming a hot chamber, a compression cylinder 152, namely a cold cylinder with a wall and a piston, forming a cold chamber surrounded by a cooler 153.

The chamber of the expansion cylinder 151 communicates with the chamber of the compression cylinder 152 via a pipe, with a heat carrying fluid 15a inside. The two pistons are mechanically connected via a mechanical output 154 shown in the figures by a system of linkage cranks and flywheel. Therefore, the Stirling engine 15 serves as a generator.

In this first embodiment, as visible in FIG. 1, the condenser 13c of the heat pump 13 and the second part of the third portion 203 of the first loop circuit 20 are located in the vicinity of the expansion cylinder 151, which enables the heat carrying fluids 20a and 30a present in those part to form a heat source for the Stirling engine 15 which produces mechanical energy. This mechanical energy derives from the difference of temperature of the heat carrying fluid 15a between the expansion cylinder 151 (hot) and the compression cylinder 152. Therefore, the more heat is provided to the expansion cylinder 151 the more mechanical energy is produced by the Stirling engine 15. Since the heat provided to the expansion cylinder 151 derives from the temperature of the heat carrying fluids 20a and 30a in the vicinity of the expansion cylinder 151, it is advantageous that there is an accumulation of energy provided by both heat-carrying fluids 20a and 30a.

Also, the hybrid solar power generation system 100 (first to third embodiments) possibly comprises an energy transformation module 16 at the output of the Stirling engine 15 to convert the mechanical energy produced by the Stirling engine 15 into electricity. This energy transformation module 16 might be a dynamo or another electromagnetic generator.

In FIGS. 1 to 4, a symbol “F” corresponds to a heat-transfer fluid in a first temperature range (low temperature) and a symbol “C” corresponds to corresponds to a heat-transfer fluid in a second temperature range (high temperature), with the temperatures of the second temperature range are greater than the temperatures of the first temperature range.

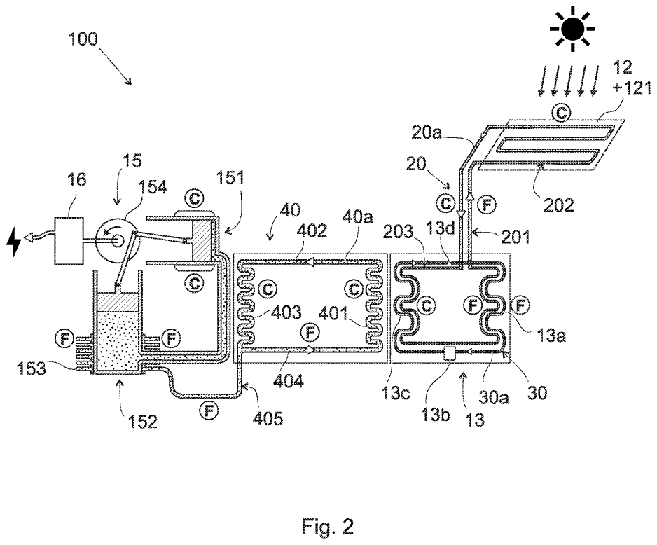

FIG. 2 is now presented in relation to a hybrid solar power generation system according to a second embodiment of the invention. All the elements previously presented in relation to the first embodiment of the invention are present, also with a further third loop circuit 40 located between on one hand, the group formed by the condenser 13c of the heat pump and the second part of the third portion 203 of the first loop circuit 20, and, on the other hand, the expansion cylinder 151 of the Stirling engine 15. Such a further third loop circuit 40 contains a heat carrying fluid 40a which forms an intermediate thermal exchanger between the heat pump 13 and the Stirling engine 15. The third loop circuit 40 is divided into a first portion 401, a second portion 402, a third portion 403 and a fourth portion 404 successively defined one after the other in a loop configuration.

This second embodiment is notably relevant when it is not possible or desirable to place the Stirling engine 15 in close proximity to the heat pump 13. It is also relevant when a storage of the produced heat is desired to allow a temporal shift of the electric production of energy compared to the natural production of the solar cycle (for example: to produce electricity at night).

In this second embodiment, as visible in FIG. 2, the condenser 13c of the heat pump 13 and the second part of the third portion 203 of the first loop circuit 20 are located in the vicinity of the first portion 401 of the third loop circuit 40. The third portion 403 of the third loop circuit 40 is located in the vicinity of the expansion cylinder 151, which enables the heat carrying fluid 40a present in the third portion 403 of the third loop circuit 40 to form a heat source for the Stirling engine 15. The heat carrying fluid 40a comes from the first portion 401 of the third loop circuit 40 up to the third portion 403 of the third loop circuit 40 via a second portion 402 of the third loop circuit 40. Also, the heat carrying fluid 40a comes from the third portion 403 of the third loop circuit 40 up to the first portion 401 of the third loop circuit 40 via a fourth portion 404 of the third loop circuit 40. Also, a derivation pipe 405 connected at the outlet end of the third portion 403 of the third loop circuit 40 is connected to the refrigerant circuit of the cooler 153 of the compression cylinder 152 of the Stirling engine 15.

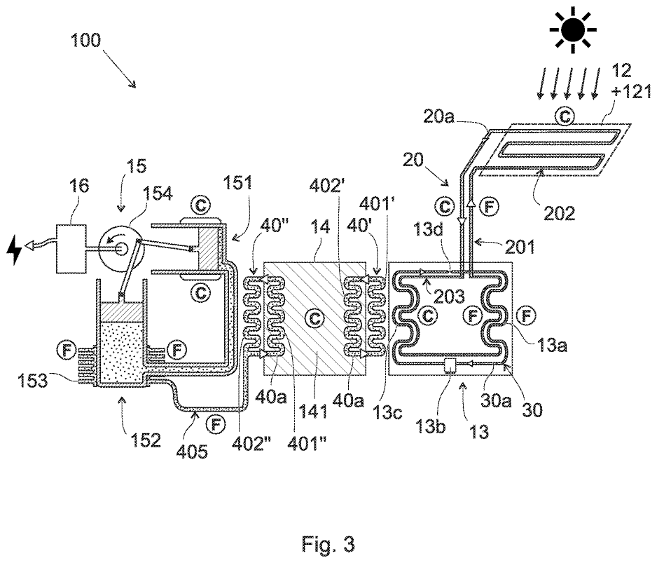

FIG. 3 is now presented in relation to a hybrid solar power generation system according to a third embodiment of the invention. All the elements previously presented in relation to the first embodiment of the invention are present, also with a further third loop circuit formed by two sub-circuits 40′ and 40″ which are located between the group formed by the condenser 13c of the heat pump and the second part of the third portion 203 of the first loop circuit 20, and the expansion cylinder 151 of the Stirling engine 15. Both third loop first and second sub-circuits 40′ and 40″ contain a heat carrying fluid 40a which forms an intermediate thermal exchanger between the heat pump 13 and the Stirling engine 15, with the further addition of a heat storage tank 14 containing a thermal energy storage material 141.

In this embodiment, a third loop circuit is divided into two loop sub-circuits 40′ and 40″ placed in series with a heat storage tank 14 between said two loop sub-circuits 40′ and 40″.

More generally, in this third embodiment, in comparison to the first embodiment, there is further a third loop circuit containing a heat-carrying fluid 40a, wherein said third loop circuit is divided into two third loop sub-circuits 40′, 40″ placed in series with a heat storage tank 14 between said two third loop sub-circuits 40′, 40″. The third loop first sub-circuit 40′ comprises a first portion 401′ adjacent to the condenser 13c of the heat pump 13 and a second portion 402′ placed in said heat storage tank 14. The third loop second sub-circuit 40″ comprises a first portion 401″ placed in said heat storage tank 14 and a second portion 402″ forming the heat source (hot source) of the Stirling engine 15. Preferably, as visible in FIG. 3, a derivation pipe 405 connected at the outlet end of the second portion 402″ of the third loop second sub-circuit 40″ is connected to the refrigerant circuit of the cooler 153 of the compression cylinder 152 of the Stirling engine 15.

There exist several possible thermal energy storage systems. The following three classifications are based on different ways of storing thermal energy:
Latent Heat Storage which relies on the changing state of the storage medium. Low temperature heat storage system uses organic phase change materials while inorganic phase change materials are best suited for high temperature heat storage. There are a multitude of phase-change materials (PCM) available, including but not limited to salts, polymers, gels, paraffin waxes and metal alloys, each with different properties.
Sensible Heat Storage: in this case, thermal energy is stored by cooling a substance (liquid or solid) without any phase change. One of the most commonly used option is a water tank, but materials such as molten salts or metals can be heated to higher temperatures and therefore offer a higher storage capacity;
Thermochemical heat Storage: this thermal-chemical storage (TCS) is based on the capability of a material to undergo chemical reactions. In one type of TCS, heat is applied to decompose certain molecules. The reaction products are then separated, and mixed again when required, resulting in a release of energy. It can involve reversible exotherm/endotherm chemical reactions with thermo-chemical materials (TCM). One example of system based on chemical reaction energy is the salt hydrate technology. The system uses the reaction energy created when salts are hydrated or dehydrated. The choice of storage material depends notably on the desired temperature range, application of thermal storage unit and size of thermal storage system.

In a non-limitative way, the heat storage tank 14 can contain as thermal energy storage material 141 any of the following: water, or other fluids (liquid or gas), molten salts, or metals that serves as an energy stock in possible replacement to an electrical battery.

Therefore, in this third embodiment, the heat collected as thermal energy can be stored in the well-insulated heat storage tank 14 to be exploited at night, thus creating a substitute for an electric battery without the disadvantages (cost, maintenance, environmental burden).

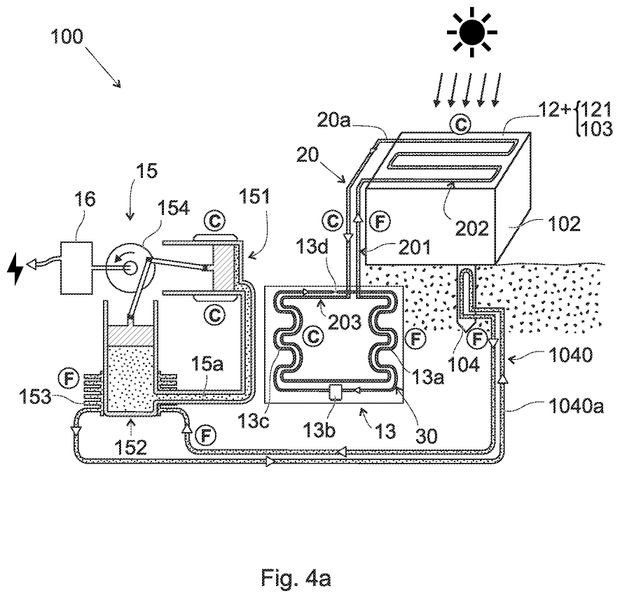

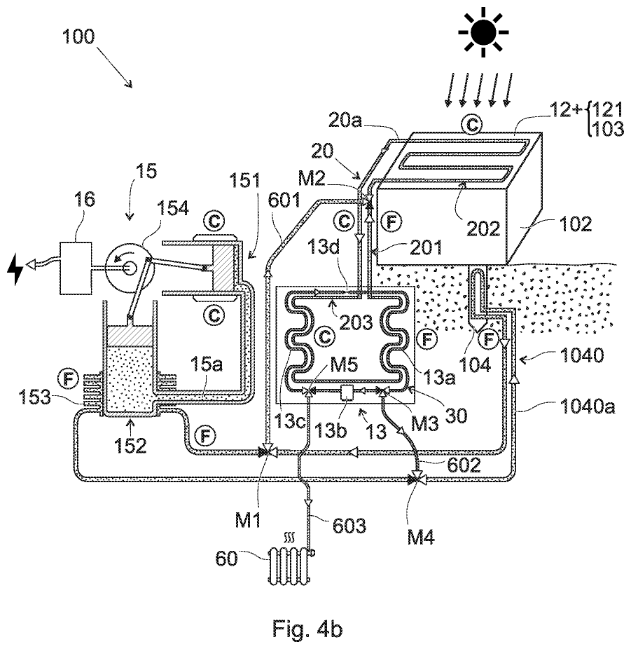

FIG. 4a is now presented in relation to a hybrid solar power generation system 100 according to a variant of the first embodiment of the invention. For that variant, the hybrid solar power generation system 100 previously described in relation with FIG. 1 is used in combination with a portion of a civil engineering work 102, for instance a building, having, on its top surface or on its roof, supporting plates 121 forming or placed on a protecting covering 103 of the outer face of the top portion of a civil engineering work 102.

This civil engineering work 102 comprises supporting pillars 104 in the underground, which form part of foundations for the portion of a civil engineering work 102 shown in FIG. 4a. In that variant, at least some of said supporting pillars 104 are equipped with a geocooling system 1040 with a circuit containing a heat-carrying fluid 1040a. Said circuit having a portion located in the underground, said circuit is used as a cold source for the Stirling engine 15. To that end, the circuit of the geocooling system 1040 is connected to the refrigerant circuit of the cooler 153 of the compression cylinder 152 of the Stirling engine 15. This corresponds to the working mode of FIG. 4a.

Due to that complementary source of cold for the cooler 153, which does not require any source of energy since it is naturally provided be the underground, it is possible to enhance the efficiency of the Stirling engine 15 by having a larger difference of temperature between the high temperature of the carrying fluid present in the expansion cylinder 151 and the low temperature of the carrying fluid present in the compression cylinder 152.

In other words, according to that variant, the supporting pillars 104 or foundation piles of are equipped with geothermal energy, which is used on request here in the other direction, i.e. geo-cooling, to provide a stable cold source for the Stirling engine 15 and optimize its efficiency.

In another working mode as described according to FIG. 4b, with the civil engineering work 102 comprising supporting pillars 104, and wherein at least some of said supporting pillars 104 are equipped with a geocooling system 1040 with a circuit containing a heat-carrying fluid 1040a, the portion of said circuit passing through the supporting pillars 104 is cooled by the heat-carrying fluid contained in the circuit of the heat pump 13. It enables the ground around the supporting pillars 104 not to be too much warm, and by this cooling to reach a temperature close to the normal ground temperature in cold season. This is both an advantage for the local natural seasonal conditions and for turning back to lower temperature in the portion of the circuit of the geocooling system 1040 located in and around the supporting pillars 104, to give a better efficiency in order form a cold source for the Stirling engine 15 at a later stage This geocooling system 1040 can be used further for delivering the heat collected by the heat carrying fluid 1040a after its passage into the cooler 153 of the Stirling engine (downstream of the cooler 153) and before the return of the heat carrying fluid 1040a in the underground at the pillar 104 location where it is cooled down again (upstream the pillar 104). This additional use can be implemented via a bypass (not shown), such branch circuit can bring that collected heat to an appropriate installation or building to which that heat is provided through another sub circuit. Such an installation could be a greenhouse, a stabling or storage building, or any farming, industrial, public or private building or installation. After the passage of the heat carrying fluid 1040a in such a branch circuit, the heat carrying fluid 1040a is colder than at the entrance of the branch circuit, which allow that heat carrying fluid 1040a to be more easily cooled down afterwards in the underground at the location of pillars 104. Alternatively, this additional use can be implemented via a manifold, namely a multiway device for distributing the heat carrying fluid 1040a to two (or more) different pipes, here the sub circuit conducting a first part of the heat carrying fluid 1040a to the installation and the portion of the loop circuit of the geocooling system 1040 directed downstream to the pillar 104.

Turning now to FIG. 4b, is presented the hybrid solar power generation system 100 of FIG. 4a, with the geocooling system 1040 and with additional optional provisions shown in operating mode, forming a second mode with respect to the working explanations given in relation with FIG. 4a. These provisions are particularly adapted for colder seasons (winter for instance for Northern countries), after a warm season during which the working of the geocooling system 1040 of FIG. 4a led to the warming of the underground in the vicinity of the of pillars 104. In this second mode of the geocooling system 1040, some more branch circuits (601 to 603) and by passes are used, thanks to manifolds (M1 to M5), in the following way. In this second mode:
the Stirling engine 15 is not connected anymore to the circuit,
the heat collected through the heat-carrying fluid 20a in the second portion 202 of the first loop circuit 20 and further warmed by the heat pump 13 can be used for heating an appropriate installation or building forming a heat consumer 60 (a remote heating network as typical example), and
the cooled fluid (gas) coming from the evaporator 13a of the heat pump 13 is bypassed and directed to the portion of the circuit of the geocooling system 1040 coming back to the supporting pillars 104 so as to cooled down the latter.

As visible in FIG. 4b, five manifolds M1-M5, constituted in this example by three-way valves, are used to connect the previously described circuits working in a different way, according to the second mode, to first to third branch circuits 601, 602 and 603.

A first branch circuit 601 is connected via a first manifold M1 to the loop circuit of the geocooling system 1040, at a location placed after the exit of the pillars 104, namely downstream the pillars 104. To this end, the first manifold M1 is closed in the direction of the refrigerant circuit of the cooler 153 of the Stirling engine 15, and is open both to the circuit portion located downstream of the pillars 104 and to the inlet of a first branch circuit 601 leading the heat-carrying fluid to the second manifold M2 which enable the heat-carrying fluid entering the second portion 202 of the first loop circuit 20, namely in direction of the photovoltaic panels 12. This second manifold M2 is closed in the connection with the third portion 203 of the first loop circuit 20, and is open both to the inlet of the second portion 202 of the first loop circuit 20 and to the downstream end of the first branch circuit 601.

A second branch circuit 602 is connected at its upstream end, via a third manifold M3, to the fluid coming from the evaporator 13a of the heat pump 13 and at its downstream end, via a fourth manifold M4, to the portion of the circuit of the geocooling system 1040 which is located upstream of the pillars 104. To that end, the third manifold M3 is located in the circuit of the heat pump 13, between the evaporator 13a and the compressor 13b. The third manifold M3 is open both in direction of the evaporator 13a (this is a connection to the section of the circuit of the heat pump 13 downstream the evaporator 13a) and in direction of the inlet of the second branch circuit 602, whereas it is closed in direction to the compressor 13b. Also, the fourth manifold M4 is located on the circuit of the geocooling system 1040, upstream of the pillars 104, with an open position with the outlet of the second branch circuit 602 and with the direction of the pillars 104, whereas it has a closed position with the section of the circuit of the geocooling system 1040 coming from the refrigerant circuit of the cooler 153 of the compression cylinder 152 of the Stirling engine 15.

In addition, a third branch circuit 603 is connected at its upstream end to the circuit of the heat pump 13, and at its downstream end, via a fifth manifold M5, to a heat consumer 60. To that end, the fifth manifold M5 is located between the compressor 13b and the condenser 13c, downstream the photovoltaic panels 12, with an open position with the inlet of the third branch circuit 603 and with the section of the circuit of the heat pump 13 located between the compressor 13b and the condenser 13c, whereas it has a closed position with the section of the circuit of the heat pump 13 containing the compressor 13b.

This variant of FIGS. 4a and 4b, with such a geocooling system 1040, can be applied in the same way to the second or the third embodiments of the hybrid solar power generation system presented above.

All loop circuits, namely the first loop circuit 20, second loop circuit (30) 30, and the possible third loop circuit 40/two third loop sub-circuit 40′, 40″ or loop circuit of the geocooling system 1040, are also possibly equipped with one pump or several pumps (not shown) for implementation of the circulation of the corresponding heat carrying fluid 20a, 30a, 40a and 1040a.

The heat-carrying fluid 20a of said first loop circuit 20 and the heat-carrying fluid 30a of said second loop circuit 30 (and if applicable the heat-carrying fluid 40a of the third loop circuit 40 and the possible heat carrying fluid 1040a of the geocooling system 1040) belong to the following list: water, liquid carbon dioxide (CO₂), liquid ammoniac (NH₃), liquid propane, liquefied petroleum gas (LPG), deionized water, inhibited glycol (ethylene glycol or propylene glycol) and water solution, dielectric fluids (Perfluorinated carbon or polyalphaolefin PAO).

Several possibilities exist for the implementation of the thermal exchange between the heat-carrying fluid 20a in the second portion 202 of the first loop circuit 20 and the photovoltaic panel(s) 12.

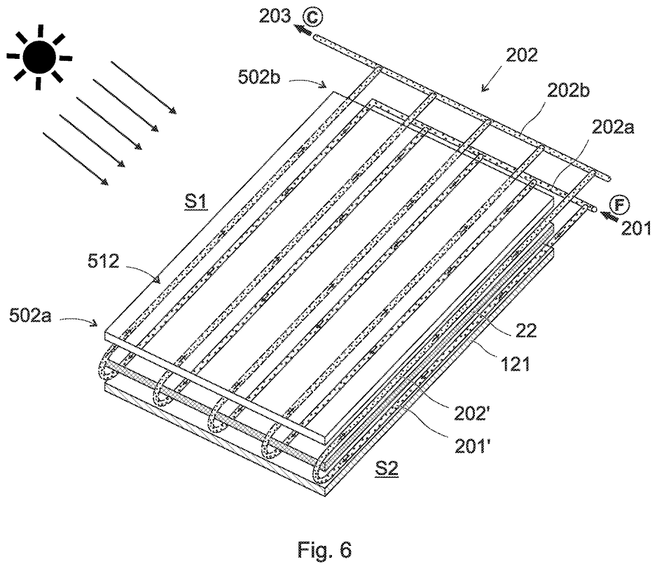

In FIG. 6, is shown an example of such implementation with a flat sheet metal as supporting plate 121 for the photovoltaic panel(s) 12, which can also form the protecting covering 103 of a (part of) a civil engineering work 102. Alternatively (not shown) a metallic sheet which is corrugated or with another type of relief can be used. Such a metallic sheet as metallic supporting plate 121 having good conductivity properties, it captures the thermal energy of its environment (space S2 under the supporting plate 121 in FIG. 6), which is turn transferred to the heat carrying fluid 20a of the first loop circuit 20, cooling thereby the sheet metal supporting plate 121. This cooling of the sheet metal supporting plate 121 contributes further to increase the efficiency of the photovoltaic panel(s) 12 which temperature has been lowered via the heat-carrying fluid 20a in the pipes of the second portion 202 of the first loop circuit 20, and via a cooled sheet metal supporting plate 121.

By placing partly or entirely the second portion 202 of the first loop circuit 20 between the photovoltaic panel(s) 12 and the sheet metal supporting plate 121, while being close as possible or in contact with any of them or both of them, this configuration brings to the heat-carrying fluid 20a circulating in said second portion 202 of said first loop circuit 20 a maximum of thermal energy (Joules). Preferably, this second portion 202 of the first loop circuit 20 has one or several specific provisions as described below in order to present a maximum of exchange surface between said second portion 202 of said first loop circuit 20 with both the photovoltaic panel(s) 12 and the sheet metal supporting plate 121.

For the most optimization of the thermal exchange efficiency of the first loop circuit 20, it corresponds to a set of successive pipes for the circulation of the heat carrying fluid 20a with the following properties.

According to an optional provision, the sections of said first and third portions 201, 203 of the first loop circuit 20 which are away from the second loop circuit 30 are thermally isolated. Those sections are two sections located between the set of photovoltaic panels 12 and the heat pump 13. This isolated two sections of pipes are not used for any heat exchange and such isolation avoid energy loss for the heat-carrying fluid 20a.

It corresponds to a set of pipes for the circulation of the said refrigerant with a high-performance thermal insulation until they enter the interstitial space between the roofing sheet (sheet metal supporting plate 121) and the photovoltaic solar modules (photovoltaic panels 12). For the section of pipe of this first loop circuit 20 present in this space, they are made of an excellent thermal conductor (e.g. aluminium) to diffuse the cold and capture the ambient heat; in the final part of the first loop circuit (return to the heat pump 13) and outside the active exchange area (sheet+solar modules) the pipes of the second portion 202 of this first loop circuit 20 are also thermally insulated.

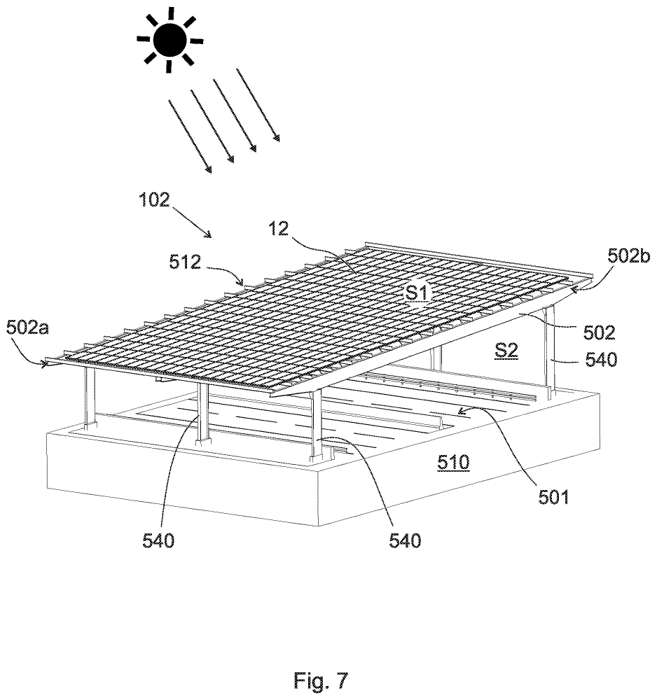

The photovoltaic panels 12 are mounted on supporting plates 121, and the second portion 202 of said first loop circuit (20) is running between said photovoltaic panels 12 and said supporting plates 121, so that the heat-carrying fluid 20a circulating in said second portion 202 of said first loop circuit 20 is able to receive some heat (quantity of joules) from the photovoltaic panels 12 which are heated by the sun heated air present in the space S1 above the photovoltaic panels 12, and also from the supporting plates 121 which are heated by the ambient air present in the space S2 under the supporting plates 121 as can be seen in FIGS. 5 and 6 (or under the photovoltaic roofing 512 in the situation illustrated in FIG. 7).

In a possible embodiment, the photovoltaic panels 12 form a set of photovoltaic panels 12 where the photovoltaic panels 12 are coplanar.

Another provision of implementation of the thermal exchange between the heat-carrying fluid 20a in the first loop circuit 20 and the photovoltaic panel(s) 12 is shown in FIGS. 5 and 6. In that case, a separation is made through a thermal insulation layer 22 placed between two stacked zones of thermal exchange. More precisely, a first array of parallel pipes 201′ is located downstream of the section of the first portion 201 of the first loop circuit 20 which is downstream of the heat pump 13. This first array of parallel pipes 201′ is part of the first portion 201 of the first loop circuit 20. A manifold 202a as shown in FIG. 6 can be used for fluidic connexion between said section and all the inlet of the first array of parallel pipes 201′. This manifold 202a forms an intake manifold 202a for the heat carrying fluid 15a flowing, from the first portion of the first loop circuit 201 (one pipe 201 in the figures), into and in the circuit located in the photovoltaic roofing 512 (this circuit being formed by the second portion of the first loop circuit 202 and with several parallel pipes.

This arrangement 201′ forms a first (bottom) zone of thermal exchange under the photovoltaic panel(s) 12.
In addition, a second array of parallel pipes 202′ is located at the upstream section of the second portion 202 of the first loop circuit 20.
This arrangement (second array of parallel pipes 202′) further forms a second (top) zone of thermal exchange under the photovoltaic panel(s) 12 and above the thermal insulation layer 22 which is placed above the first zone of thermal exchange (first array of parallel pipes 201′).
Each pipe of the first array of parallel pipes (201′ in FIGS. 5 and 6) contains the heat carrying fluid 20a which is in the first temperature range when entering the bottom or first zone of thermal exchange, namely entering the first array of parallel pipes 201′via the intake manifold 202a, and which is heated up along its circulation along the supporting plate 121 at ambient air temperature of the space S2.
The downstream end of each pipe of the first array of parallel pipes 201′ (at the left in FIGS. 5 and 6) is connected to an upstream end of a corresponding pipe of the second array of parallel pipes 202′.

Therefore, the heat carrying fluid 20a is flowing in parallel pipes from the first array of parallel pipes 201′ into the second array of parallel pipes 202′, namely in the top or second zone of thermal exchange, between the thermal insulation layer 22 and the photovoltaic panel 12, where it is further and strongly heated up by the warm and potentially hot photovoltaic panel(s) 12.

A manifold 202b as shown in FIG. 6 can be used for fluidic connection between all the downstream end of the second array of parallel pipes 202′ and the upstream section of the second portion 202 of the first loop circuit 20 (one pipe 203 in the figures). One understands that downstream of the second portion 202 of the first loop circuit 20, for directing the flow of heat carrying fluid 15a towards the third portion of the first loop circuit 203. This manifold 202b forms an exhaust manifold for the heat carrying fluid 15a flowing in the upstream section of the second portion 202 of the first loop circuit 20, formed by the second array of parallel pipes 202′. When entering the third portion 203 of the first loop circuit 20, the heat-carrying fluid 20a flows with a high temperature, situated in a second temperature range which is greater than the temperatures of the first temperature range.

In order to optimize the thermal exchange into those first and second zones of thermal exchange, as mentioned above, an insulation layer 22 is placed between the first array of parallel pipes 201′ and the second array of parallel pipes 202′, making a thermal and physical separation between them.

In addition to warming the heat-carrying fluid 20a of the first loop circuit 20, this arrangement cools down the photovoltaic panel(s) 12 and their environment (including the supporting plate 121), increasing thereby the thermal efficiency of the photovoltaic panel(s) 12.

Therefore, according to the arrangement of FIGS. 5 and 6, an insulating layer 22 is placed between said photovoltaic panels 12 and said supporting plates 121, forming thereby a first zone of thermal exchange between said supporting plates 121 and said insulating layer 22 (above said insulating layer 22 on FIGS. 5 and 6), and a second zone of thermal exchange is placed between said insulating layer 22 and said photovoltaic panels 12 (below said insulating layer 22 on FIGS. 5 and 6),
wherein a downstream section of said first portion 201 of the first loop circuit 20 is formed by a first array of parallel pipes 201′ located in said first zone of thermal exchange, wherein a upstream section of said second portion (202) of said first loop circuit (20) is formed by a second array of parallel pipes 202′ located in said second zone of thermal exchange,
and wherein the downstream end of each pipe of the first array of parallel pipes 201′ (at the left in FIGS. 5 and 6) is connected to an upstream end of a corresponding pipe of the second array of parallel pipes 202′.

The solution according to the present invention is applicable for instance to existing or future installations of solar modules with large surface of photovoltaic panels. Such installations with solar modules represent high investment, notably in terms of metallic structure, and the combination with a heat pump and a Sterling engine as described in the present text represent important energy income for a better spreading of the cost. When applied to upper surface of any civil engineering work forming thereby a photovoltaic roofing system, for instance protecting covering placed above highways, this reduces the cost for the infrastructure supporting the photovoltaic panels, so that the energy gained (thermal energy and/or mechanical energy and/or electric energy) is even more less investment costly.

An example of an installation of such a photovoltaic roofing system 512 forming part of a hybrid solar power generation system according to the invention is visible on FIG. 7.

On FIG. 7, a motorway 501 is covered by a canopy 502 forming a covering comprising a photovoltaic roofing 512, which is a raised structural part mounted on upright supports 540. These upright supports 540 raise from the ground 510, along the two sides of the motorway 501, to support the photovoltaic roofing 512.
More precisely, in FIG. 7, the civil engineering work 102 is a motorway facility, comprising a canopy 502 covering a portion of motorway 501, said canopy 202 being mounted over upright supports 40. Such a canopy 202 is not only a physical protection for the portion of motorway 501 but also a deflector for creating airflow circulation below the canopy 502 thanks to the supporting structure. This airflow circulation is also due to convection thanks to heat transfer between the motorway surface and the air volume located under the photovoltaic roofing 512 and also thanks to the vehicle traffic.
As shown in FIG. 7, the canopy 502 also allows for said photovoltaic panels 12 and photovoltaic roofing 512 to be located on the upper face of said canopy 202, with the photovoltaic panels 12 forming the upper surface of the photovoltaic roofing 512.

In addition to its function as a part of the hybrid solar power generation system 100 according to the invention, a structure as shown in FIG. 7 provides additional advantages to both motorway operators and users. This structure, particularly its security barrier and canopy 502 with photovoltaic roofing 512, acts as a sound insulator and ensures important noise reduction. The overhead canopy structure 502 protects the road surface of the motorway 501 from snowfall, thus eliminating or greatly reducing the need for winter maintenance such as salting and snow ploughing. The canopy 502 also protects from excessive heat and UV rays, thus considerably extending the service life of the road surface of the motorway 501. The canopy 502 can have a slanted overhead surface allowing for rainwater collection as visible on FIG. 7. The supporting structure (canopy 502 and upright supports 540) can be adapted to house cables and other conduits.

As can be seen in the embodiment shown in FIG. 7, the canopy 502 has a slanted overhead surface between the lateral sides 502a and 202b. The lateral sides 502a and 502b of the canopy 502 correspond to the sides of the canopy placed parallel to the traffic direction of the motorway 501. In this example, the canopy 502 has a plate shape. This inclined configuration of the top and bottom surfaces of the canopy 502 allows rainwater collection and evacuation but also brings warmed up air collection under the canopy 502 towards the upper side or second lateral side 502b of the canopy 502 (on the right of FIGS. 5 to 7). Depending on the local temperature conditions, this lateral inclined orientation of the canopy 502, with a first lateral side 502a lower than the second lateral side 502b, promote the circulation of warm air towards the second lateral side 502b. This situation raises the heat exchange performance of the first (bottom) zone of thermal exchange, namely heat exchange between the first array of parallel pipes 201′ sand the supporting plate 121, which is preferably a sheet metal supporting plate 121. This heat exchange performance is generally more important on the second lateral side 502b of the canopy 502 than on the first lateral side 502a of the canopy 502.

Preferably, the inclination of the canopy 502, i.e., between the lower first lateral side 502 a and the higher second lateral side 502b, is between 5 and 15% with respect to a horizontal surface (i.e., an angular range of 3 to 9 degrees with respect to a horizontal surface), preferably more than 6% (more than 3.5 degrees), preferably between 8 and 12% (angular range of 4.5 to 7 degrees). These possible inclination range values relate at least to the top surface of the canopy 502. These possible inclination range values can also relate to the bottom (low) surface of the canopy 502.

The solution according to the present invention allows to exploit the residual solar energy (i.e. not exploited by the photovoltaic part) with a good efficiency.

The operation of the system and its performance can be presented and described in a possible real situation as following:
Stage 1: Sending cold to the photovoltaic collection area will lower the temperature of the solar modules and increase their efficiency. This cold corresponds to the heat-carrying fluid 20a of the first loop circuit 20 present in the first portion 201 (low temperature range) for circulation of the fluid in a first temperature range.

Consider the following theoretical example: a summer day with a 30° C. ambient temperature, solar modules (photovoltaic panels 12) temperature at 70° C., circulation of a heat-carrying fluid 20a of the first loop circuit 20 at −15° C. Those temperature conditions lower the temperature of the solar modules (as well as the supporting plate 121 (metal sheet) having a temperature between 30° C. ambient and 70° C.) to 20° C. This brings an increase of the efficiency of the solar modules (photovoltaic panels 12) of about 50*0.35%, corresponding to a +17.5% in relative terms, i.e., an increase of about 20 up to 23.5% or +3.5% in absolute terms of the efficiency of the photovoltaic modules or panels 12.

This first energy gain will partially compensate the energy invested in the thermal cycle of the heat pump 13.

Stage 2: Once the refrigerant or heat-carrying fluid 20a has been recompressed, its temperature will rise sharply, i.e. in the theoretical example above, around 100° C. Preferably, the circulation of the refrigerant is organized so that it comes as close as possible to the temperature of the solar modules (photovoltaic panels 12) at the end of the heating cycle, namely before entering in thermal exchange with the second loop circuit 30 of the heat pump 13.

This hot heat-carrying fluid 20a becomes at this moment the heat source of the Stirling engine 15 as presented above in relation to FIG. 1.

The idea of sending an artificially cooled heat-carrying fluid 20a, i.e., significantly lower than the immediate environment, makes sense here, because not only will the solar energy directly sent to the collection surface of the sheet metal supporting plate 121 in addition to the solar energy transformed by the photovoltaic panels 12 be exploited, but also, admittedly to a lesser extent, that of the immediate environment which will be captured by convection and/or turbulence, thus transforming the apparently passive sheet metal supporting plate 121 into an active component of the installation.

The energy gained here will therefore be the addition of the residual thermal part on the collection surface itself (100−20==>80% of the total solar radiation) in addition to the part gained on the immediate environment thanks to the sheet metal supporting plate 121 having undergone forced cooling. The final value will depend on a multitude of factors such as the nature of the immediate environment (human constructions or nature), or natural turbulence (wind). Imagining a 20% here seems rather conservative, especially if the invention is deployed on active motorway.

In the end, this 100% solar radiation equivalent will pass through the Stirling engine 15 with its own efficiency. The best Stirling engines have an efficiency of 40%, the target efficiency of the solution is estimated to 40% (Stirling eff.)*100% (solar radiation equivalent) +20% (PV eff.)+3.5% (gain on photovoltaic panels)-energy invested in the heat pump (estimate 15% solar radiation equivalent−)==>48.5%. This efficiency is certainly to be considered as a minimum target. Each improvement in any of its components will improve the whole at least that much.

An arrangement according to the present invention is able to more than double the efficiency of photovoltaic panels alone, while obtaining a part of the energy in a manageable form, as the heat for the Stirling engine 15 can relatively easily be stored, especially if we are talking about short cycles such as the day-night cycle, or a smoothing over a few days.

### REFERENCE SIGNS USED IN THE FIGURES

100 Hybrid solar power generation system
102 Civil engineering work
103 Protecting covering
104 Supporting pillar
1040 Geocooling system
1040a Heat carrying fluid
12 Photovoltaic panel(s)
121 Supporting plate
13 Heat pump
13a Evaporator
13b Compressor
13c Condenser
13d Metering device
14 Heat storage tank
141 Thermal energy storage material
15 Stirling engine
151 Expansion cylinder=Hot cylinder: wall and piston
152 Compression cylinder=cold cylinder: wall and piston
153 Cooler
154 Mechanical output: Linkage crank and flywheel
15a Heat carrying fluid
16 Energy transformation module
20 First loop circuit
20a Heat carrying fluid
201 First portion of the first loop circuit
201′ First array of parallel pipes
202 Second portion of the first loop circuit
202a Intake manifold of the photovoltaic roofing
202b Exhaust manifold of the photovoltaic roofing
202′ Second array of parallel pipes
203 Third portion of the first loop circuit
22 Insulation layer
30 Second loop circuit
30a Heat carrying fluid
40 Third loop circuit
40′ Third loop first sub-circuit
40″ Third loop second sub-circuit
40a Heat carrying fluid
401 First portion of the third loop circuit
402 Second portion of the third loop circuit
403 Third portion of the third loop circuit
404 Fourth portion of the third loop circuit
405 Derivative pipe of the third loop circuit
401′ First portion of the third loop first sub-circuit
402′ Second portion of the third loop first sub-circuit
401″ First portion of the third loop second sub-circuit
402″ Second portion of the third loop second sub-circuit
501 Motorway
502 Canopy
502a First lateral side of the canopy (lower side)
502b Second lateral side of the canopy (upper side)
510 Ground
512 Photovoltaic roofing
540 Upright support
S1 Space above the photovoltaic roofing
S2 Space under the canopy
60 Heat consumer
601 First branch circuit
602 Second branch circuit
603 Third branch circuit
M1 First manifold
M2 Second manifold
M3 Third manifold
M4 Fourth manifold
M5 Fifth manifold

1-19. (canceled)

20. Hybrid solar power generation system comprising:
a set of photovoltaic panels,
a first loop circuit containing a heat-carrying fluid able to circulate along the first loop circuit, said first loop circuit defining a first portion for circulation of the fluid in a first temperature range, a second portion adjacent to said photovoltaic panels for thermal exchange between the fluid and said photovoltaic panels and a third portion for circulation of the fluid in a second temperature range, wherein the temperatures of the second temperature range are greater than the temperatures of the first temperature range,
a heat pump with a second loop circuit containing a heat-carrying fluid, said second loop circuit passing successively through an evaporator, a compressor, a condenser and a metering device, where the heat source of said evaporator is the heat-carrying fluid present in said third portion of the first loop circuit, and
a Stirling engine, where the Stirling engine's heat source derives from heated fluid refrigerant present in a portion of the second loop circuit placed between the compressor, and the metering device,
wherein said photovoltaic panels are mounted on supporting plates, and wherein said second portion of said first loop circuit is running between said photovoltaic panels and said supporting plates, so that the heat-carrying fluid circulating in said second portion of said first loop circuit is able to receive heat from the photovoltaic panels and from the supporting plates,
wherein an insulating layer is placed between said photovoltaic panels and said supporting plates, forming thereby a first zone of thermal exchange located between said supporting plates and said insulating layer, and a second zone of thermal exchange located between said insulating layer and said photovoltaic panels,
wherein a downstream section of said first portion of the first loop circuit is formed by a first array of parallel pipes located in said first zone of thermal exchange,
wherein an upstream section of said second portion of said first loop circuit is formed by a second array of parallel pipes located in said second zone of thermal exchange, and
wherein the downstream end of each pipe of the first array of parallel pipes is connected to an upstream end of a corresponding pipe of the second array of parallel pipes.

21. Hybrid solar power generation system according to claim 20, wherein said supporting plates are metallic supporting plates.

22. Hybrid solar power generation system according to claim 20, wherein said supporting plates of said set of photovoltaic panels are forming an inclined support with a first lateral side lower than a second lateral side.

23. Hybrid solar power generation system according to claim 22, wherein the upstream end of each pipe of the first array of parallel pipes and the downstream end of each pipe of the second array of parallel pipes are adjacent to the second lateral side of said inclined support which is higher than the first lateral side of said inclined support.

24. Hybrid solar power generation system according to claim 20, wherein it further comprises a third loop circuit containing a heat-carrying fluid, said third loop circuit defining successively a first portion adjacent to the condenser of the heat pump, a second portion between the heat pump and the Stirling engine, a third portion forming the heat source (hot source) of the Stirling engine, and a fourth portion between the Stirling engine and the heat pump.

25. Hybrid solar power generation system according to claim 20, wherein it further comprises a third loop circuit containing a heat-carrying fluid, wherein said third loop circuit is divided into two third loop sub-circuits placed in series with a heat storage tank between said two third loop sub-circuits, wherein said third loop first sub-circuit comprises a first portion adjacent to the condenser of the heat pump and a second portion placed in said heat storage tank, and wherein said third loop second sub-circuit comprises a first portion placed in said heat storage tank and a second portion forming the heat source (hot source) of the Stirling engine.

26. Hybrid solar power generation system according to claim 20, wherein the photovoltaic panels of said set of photovoltaic panels are coplanar.

27. Hybrid solar power generation system according to claim 20, wherein it further comprises a module for transformation of the mechanical motion produced by the Stirling motor into electrical output.

28. Hybrid solar power generation system according to claim 20, wherein sections of said first and third portions of the first loop circuit which are away from the second loop circuit are thermally isolated.

29. Hybrid solar power generation system according to claim 20, wherein heat-carrying fluid of said first loop circuit and the heat-carrying fluid of said second loop circuit is selected from the group consisting of: water, liquid carbon dioxide, liquid ammonia, liquid propane, liquefied petroleum gas, deionized water, a solution of inhibited glycol and water, and a dielectric fluid.

30. Civil engineering work comprising a protecting covering with an outer surface able to be exposed to sunlight, and comprising a hybrid solar power generation system according to claim 1, wherein said photovoltaic panels are located on said protecting covering.

31. Civil engineering work as in claim 30, wherein said photovoltaic panels, said insulating layer, said supporting plates, said first array of parallel pipes and said second array of parallel pipes are located on said protecting covering, forming thereby a photovoltaic roofing.

32. Civil engineering work as in claim 30, wherein the civil engineering work comprises a portion of motorway covered with said protecting covering forming thereby a canopy.

33. Civil engineering work as in claim 31, wherein the civil engineering work comprises a portion of motorway covered with said photovoltaic roofing.

34. Civil engineering work as in claim 32, wherein said protecting covering is inclined with two lateral sides running alongside the two sides of the motorway, the first lateral side of said protecting covering being lower than the second lateral side said protecting covering.

35. Civil engineering work as in claim 30, wherein each pipe of the first array of parallel pipes and of the second array of parallel pipes extends between the first lateral side of said protecting covering and the second lateral side of said protecting covering.

36. Civil engineering work as in claim 30, wherein the upstream end of each pipe of the first array of parallel pipes and the downstream end of each pipe of the second array of parallel pipes are adjacent to the second lateral side said protecting covering which is higher than the first lateral side of said protecting covering.

37. Civil engineering work as in claim 30, wherein said civil engineering work comprises supporting pillars, and wherein at least some of said supporting pillars are equipped with a geocooling system with a circuit containing a heat-carrying fluid, said circuit having a portion located in the underground, wherein said circuit forms a cold source for the Stirling engine.

38. Civil engineering work as in claim 30, wherein said civil engineering work comprises supporting pillars, and wherein at least some of said supporting pillars are equipped with a geocooling system with a circuit containing a heat-carrying fluid, wherein the portion of said circuit passing through the supporting pillars is cooled by the heat-carrying fluid contained in the circuit of the heat pump.

39. Hybrid solar power generation system according to claim 29, wherein the inhibited glycol is one of ethylene glycol and propylene glycol, and wherein the dielectric fluid is one of perfluorinated carbon and polyalphaolefin PAO.
